(19) United States
(12) Patent Application Publication
(10) Pub. No.: US 2025/0249769 A1
(43) Pub. Date: Aug. 7, 2025

(54) ELECTRIFIED VEHICLE

(71) Applicant: TOYOTA JIDOSHA KABUSHIKI KAISHA, Toyota-shi (JP)

(72) Inventor: Kosuke HIRANO, Toyota-shi (JP)

(73) Assignee: TOYOTA JIDOSHA KABUSHIKI KAISHA, Toyota-shi (JP)

(21) Appl. No.: 19/018,272

(22) Filed: Jan. 13, 2025

(30) Foreign Application Priority Data
Feb. 5, 2024 (JP) 2024-015882

(51) Int. Cl. B60L 53/24; B60L 53/62; H02M 1/00; H02M 7/483

(52) U.S. Cl. CPC B60L 53/24; B60L 53/62; H02M 1/0032; H02M 7/483

(57) ABSTRACT

An electrified vehicle includes: a motor including three-phase coils connected to each other at a neutral point; a power storage device; an inverter connected to the power storage device and configured to drive the motor; and a control device configured to, during external charging in which electric power supplied from an external power supply to the neutral point is supplied to the power storage device along with voltage conversion, control each phase of the motor and the inverter by setting a duty command using feedback control to cancel out a difference between a phase current and a phase current command based on a current command at the neutral point. The control device is configured to, when the phase current is in a transient state during the external charging, larger value for a gain in the feedback control than when the phase current is not in the transient state.

### CROSS-REFERENCE TO RELATED APPLICATION

This application claims priority to Japanese Patent Application No. 2024-015882 filed on Feb. 5, 2024, incorporated herein by reference in its entirety.

### BACKGROUND

### 1. Technical Field

The present disclosure relates to an electrified vehicle.

### 2. Description of Related Art

There has been proposed an electrified vehicle including a motor including three-phase coils connected to each other at a neutral point, a power storage device, and an inverter connected to the power storage device via a power line and configured to drive the motor (see, for example, Japanese Unexamined Patent Application Publication No. 2011-15495 (JP 2011-15495 A)). This electrified vehicle can perform external charging in which electric power supplied from an external power supply to the neutral point is supplied to the power storage device along with voltage conversion by the motor and the inverter.

### SUMMARY

In such an electrified vehicle, for example, each phase of the motor and the inverter is controlled during the external charging. At this time, each phase of the motor and the inverter is controlled by setting a duty command using feedback control to cancel out a difference between a phase current and a phase current command based on a current command at the neutral point. In the external charging, there is no disturbance such as rotation fluctuation of the motor unlike in the traveling. Therefore, it is assumed that a relatively small value is used for the gain in the feedback control. For this reason, it may be impossible to sufficiently cope with a transient state in which a transient change of the phase current of the motor is assumed, as in a case where the external charging is started or an abnormality occurs during the external charging and the external charging is stopped urgently.

The present disclosure provides an electrified vehicle that ensures responsiveness in a transient state.

The electrified vehicle according to the present disclosure adopts the following measures.

The electrified vehicle according to the present disclosure is an electrified vehicle including:
a motor including three-phase coils connected to each other at a neutral point;
a power storage device;
an inverter connected to the power storage device via a power line and configured to drive the motor; and
a control device configured to, during external charging in which electric power supplied from an external power supply to the neutral point is supplied to the power storage device along with voltage conversion by the motor and the inverter, control each phase of the motor and the inverter by setting a duty command using feedback control to cancel out a difference between a phase current and a phase current command based on a current command at the neutral point.
   The control device is configured to, when the phase current is in a transient state during the external charging, use a larger value for a gain in the feedback control than when the phase current is not in the transient state.

The electrified vehicle according to the present disclosure may perform the external charging in which electric power supplied from an external power supply to the neutral point is supplied to the power storage device along with voltage conversion by the motor and the inverter. In this case, each phase of the motor and the inverter is controlled by setting the duty command using the feedback control to cancel out the difference between the phase current and the phase current command based on the current command at the neutral point. In this case, when the phase current is in the transient state during the external charging, a larger value is used for the gain in the feedback control than when the phase current is not in the transient state. This makes it possible to increase (ensure) the responsiveness of the phase current to the phase current command when the phase current is in the transient state.

In the electrified vehicle according to the present disclosure, the control device may be configured to, when the phase current is in the transient state during the external charging, use, for the gain, a value that is larger than when the phase current is not in the transient state and that decreases as the phase current command or the phase current increases.

In this case, the inductance of the phase decreases due to magnetic saturation when the phase current is large. Therefore, it is possible to achieve both the stability of the control of the phase and the responsiveness of the phase current to the phase current command.

In the electrified vehicle according to the present disclosure, the control device may be configured to use, as the feedback control, a feedforward term based on a voltage command at the neutral point and a voltage on the power line, and a feedback term based on the phase current command, the phase current, and the gain.

In the electrified vehicle according to the present disclosure, the control device may be configured to determine that the phase current is in the transient state in response to satisfaction of at least one of a condition that a change amount of the current command or the phase current command at the neutral point per unit time is equal to or larger than a predetermined change amount and a condition that an abnormality that leads to termination of the external charging has occurred.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 20 and a charging station 80 according to an embodiment;

FIG. 2 is a processing block diagram illustrating an exemplary processing block of the vehicle ECU60 related to the control of the three-phase step-up converter 21 during external charging in the second charging mode;

FIG. 3 is a flow chart illustrating an exemplary gain setting process as a process of the gain setting unit 150 executed by the vehicle ECU60;

FIG. 4 is an explanatory diagram illustrating an exemplary U-phase proportional term gain map; and

FIG. 5 is an explanatory diagram illustrating an example of a U-phase integral term gain map.

### DETAILED DESCRIPTION OF EMBODIMENTS

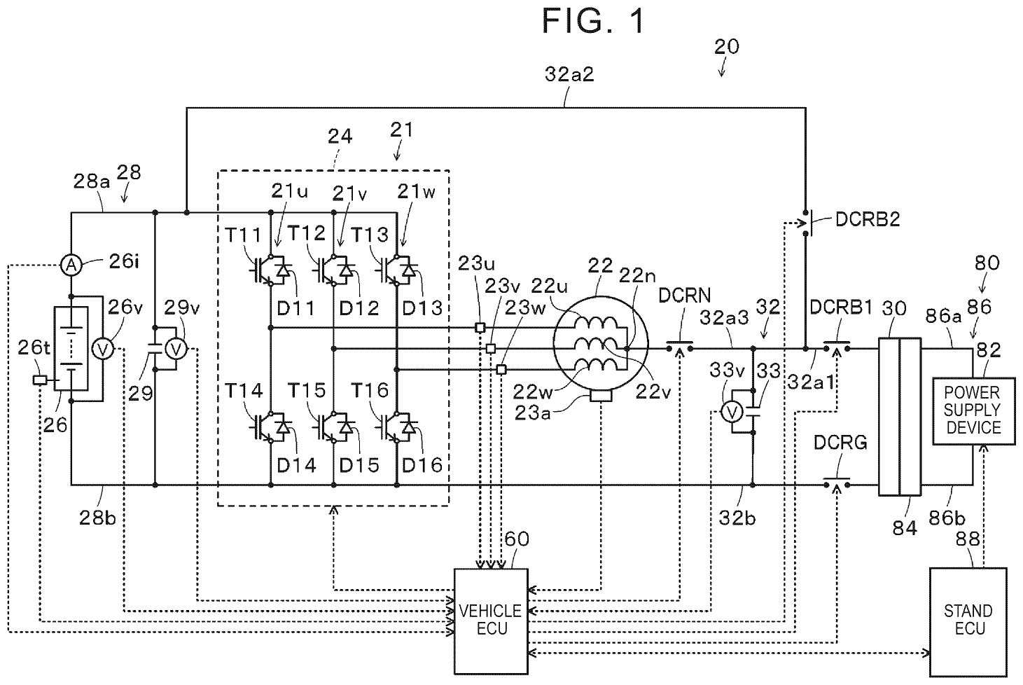

Embodiments for carrying out the present disclosure will be described with reference to the drawings. FIG. 1 is a schematic configuration diagram of a battery electric vehicle 20 and a charging station 80 according to an embodiment. As illustrated, battery electric vehicle 20 includes a motor 22, an inverter 24, a battery 26 as a power storage device, and a power line 28 having a positive electrode side line 28a and a negative electrode side line 28b. As illustrated, battery electric vehicle 20 includes a vehicle connector 30, a power line 32 having positive electrode side lines 32a1, 32a2, 32a3 and a negative electrode side line 32b, relays DCRG, DCRB1, DCRB2, DCRN, and a vehicle electronic control unit (hereinafter referred to as a “vehicle ECU”) 60 as a control device.

The motor 22 is configured as a three-phase AC motor, and includes a rotor in which permanent magnets are embedded in a rotor core, and a stator in which U-phase, V-phase, and W-phase coils 22u, 22v, 22w are respectively wound around the stator core. A neutral point 22n is formed by connecting the U-phase, V-phase, and W-phase coils 22u, 22v, 22w. The rotor of the motor 22 is connected to a drive shaft connected to the drive wheels via a differential gear.

Inverter 24 is used to drive motor 22 and is connected to battery 26 via positive electrode side line 28a and negative electrode side line 28b of power line 28. Inverter 24 has transistors T11 to T16 as six switching elements, and six diodes D11 to D16. Transistors T11 to T16, respectively, are arranged in pairs of two so as to be the source side and sink side with respect to the positive electrode side line 28a and the negative electrode side line 28b. The connection point of the transistors T11, T14 of the pair, the connection point of the transistors T12, T15 of the pair, and the connection point of the transistors T13, T16 of the pair are connected to the coils 22u, 22v, 22w of the U phase, the V phase, and the W phase of the motor 22, respectively. The six diodes D11 to D16 are connected in parallel from the six transistors T11 to T16, respectively. Inverter 24 converts the DC power from battery 26 into three-phase AC power by pulse-width modulation control (PWM control) and supplies the converted AC power to motor 22. A capacitor 29 is connected to the positive electrode side line 28a and the negative electrode side line 28b.

The battery 26 is configured as, for example, a lithium-ion secondary battery or a nickel-hydrogen secondary battery, and as described above, is connected to the inverter 24 via the positive electrode side line 28a and the negative electrode side line 28b of the power line 28.

The vehicle connector 30 is configured to be connectable to the stand connector 84 of the charging station 80. One end of each of the positive electrode side lines 32a1, 32a2, 32a3 of the power line 32 is connected to each other. The other end of the positive electrode side line 32al is connected to the vehicle-connector 30. The other end of the positive electrode side line 32a2 is connected to the positive electrode side line 28a of the power line 28. The other end of the positive electrode side line 32a3 is connected to the neutral point 22n of the motor 22. One end of the negative electrode side line 32b is connected to the vehicle connector 30, and the other end is connected to the negative electrode side line 28b of the power line 28. A capacitor 33 is connected to the positive electrode side line 32a3 and the negative electrode side line 32b.

The relay DCRB1 is provided in the positive electrode side line 32al. The relay DCRB2 is provided in the positive electrode side line 32a2. The relay DCRN is provided on the neutral point 22n side of the motor 22 rather than the connecting point with the capacitor 33 in the positive electrode side line 32a3. The relay DCRG is disposed closer to the vehicle connector 30 than the connecting point of the negative electrode side line 32b to the capacitor 33.

When the relay DCRB1, the relay DCRN, and the relay DCRG are on, the motor 22 and the inverter 24 constitute a three-phase step-up converter 21 between the positive electrode side lines 32a1, 32a3 and the negative electrode side line 32b of the power line 32 and the positive electrode side line 28a and the negative electrode side line 28b of the power line 28. The three-phase step-up converter 21 has three-phase (U-phase, V-phase, and W-phase) voltage converters 21u, 21v, 21w connected in parallel to the power line 32 and the power line 28. The U-phase voltage converter 21u includes a U-phase coil 22u of the motor 22 and transistors T11, T14 of the inverter 24. The V-phase voltage converter 21v includes the V-phase coil 22v of the motor 22 and the transistors T12, T15 of the inverter 24. The W-phase voltage converter 21w includes a W-phase coil 22w of the motor 22 and transistors T13, T16 of the inverter 24.

The vehicle ECU60 includes a microcomputer, and the microcomputer includes a CPU, ROM, RAM, a flash memory, an input/output port, and a communication port. The vehicle ECU60 receives signals from various sensors. For example, the vehicle ECU60 receives the rotational position Om of the rotor of the motor 22 from the rotational position sensor 23a, and the U-phase, V-phase, and W-phase currents Iu, Iv, Iw of the motor 22 from the current sensors 23u, 23v, 23w. The vehicle ECU60 also receives the voltage Vb of the battery 26 from the voltage sensor 26v, the current Ib of the battery 26 from the current sensor 26i, and the temperature ab of the battery 26 from the temperature sensor 26t. The vehicle ECU60 also receives the voltage VH of the capacitor 29 (power line 28) from the voltage sensor 29v and the voltage VL of the capacitor 33 (power line 32) from the voltage sensor 33v.

The vehicle ECU60 outputs various control signals. For example, the vehicle ECU60 outputs a control signal from the transistors T11 to T16 of the inverter 24, a control signal to the relay DCRB1, a control signal to the relay DCRB2, a control signal to the relay DCRN, and a control signal to the relay DCRG. The vehicle ECU60 calculates the electric angle θe and the rotational speed Nm of the motor 22 based on the rotational position Om of the rotor of the motor 22. The vehicle ECU60 calculates the power storage ratio SOC of the battery 26 based on the integrated value of the current Ib of the battery 26, and calculates the input limit Win which is the allowable input power of the battery 26 based on the power storage ratio SOC and the temperature ab of the battery 26. The vehicle ECU60 is capable of communicating with an electronic control unit (hereinafter referred to as a “stand ECU”) 88 of the charging station 80 at a charging point such as a home or a charging station.

The charging station 80 is provided at a charging point such as a home or a charging station. The charging station 80 includes a power supply device 82, a stand connector 84, and a stand ECU88. The power supply device 82 is connected to the stand connector 84 via the positive electrode side line 86a and the negative electrode side line 86b of the power line 86. The power supply device 82 is configured to convert AC power from the power system into DC power, and to adjust the output voltage and the output power so as to be able to output the AC power. The stand connector 84 is configured to be connectable to a battery electric vehicle 20 vehicle connector 30. When the stand connector 84 and the vehicle connector 30 are connected, the positive electrode side line 86a and the positive electrode side line 32al are connected, and the negative electrode side line 86b and the negative electrode side line 32b are connected.

The stand ECU88 comprises a microcomputer as well as a vehicle ECU60. The stand ECU88 receives the output voltage Vs of the power supply device 82 from the voltage sensor and the output current Is of the power supply device 82 from the current sensor. The stand ECU88 provides a control signal to the power supply device 82. The stand ECU88 calculates an output power Ps based on the output voltage Vs and the output current Is. The stand ECU88 is capable of communicating with battery electric vehicle 20 vehicle ECU60.

In battery electric vehicle 20 of the embodiment, the vehicle connector 30 and the stand connector 84 may be connected to each other during parking of the vehicle at the charging point, so that the charging starting condition may be satisfied. In this case, the power supply from the power supply device 82 of the charging station 80 is started, and the external charging that is the charging of the battery 26 using the power from the power supply device 82 is started. After that, when the charging end condition is satisfied, the power supply from the power supply device 82 of the charging station 80 is terminated, and the external charging is terminated. As the charging start condition, for example, a condition that the user instructs to start external charging is used. As the charge termination condition, for example, a condition in which the power storage ratio SOC of the battery 26 reaches a predetermined ratio near the full charge is used. The external charging is performed in the first charging mode or the second charging mode. In the first charge mode, the relay DCRB1, the relay DCRB2, and the relay DCRG are turned on. As a result, the electric power from the power supply device 82 is supplied to the battery 26 without being voltage-converted, and the battery 26 is charged. In the second charging mode, the relay DCRB1, the relay DCRBN, and the relay DCRG are turned on, and the power from the power supply device 82 is supplied to the battery 26 with voltage-conversion by the three-phase step-up converter 21 (the motor 22 and the inverter 24) to charge the battery 26.

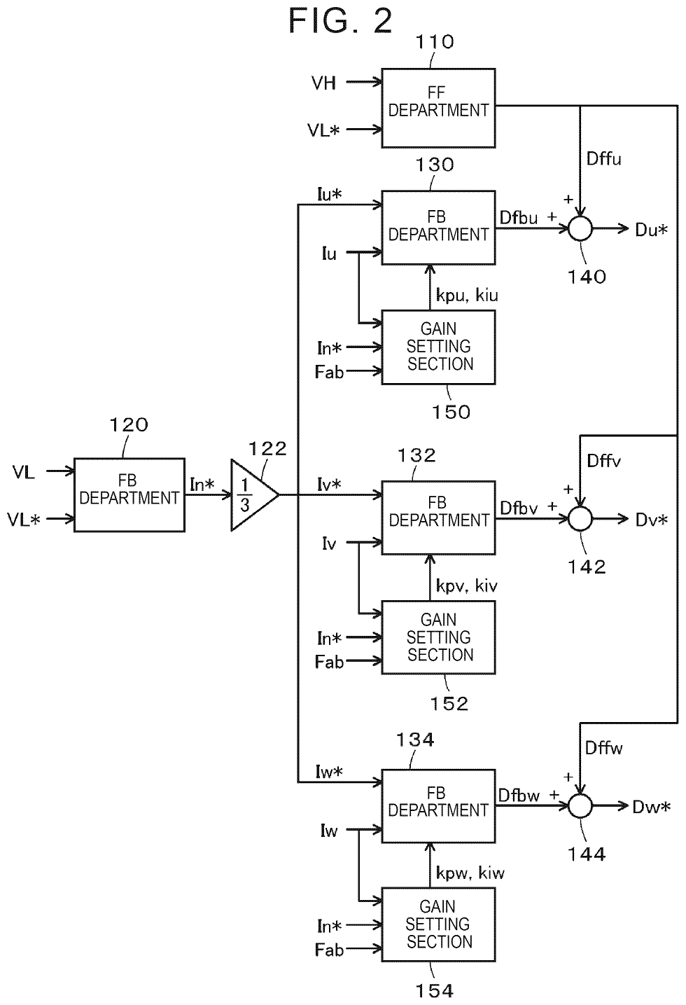

Next, the operation of battery electric vehicle 20 of the embodiment, in particular, the control of the three-phase step-up converter 21 by the vehicle ECU60 (the control of the inverter 24) during the external charging in the second charging mode will be described. FIG. 2 is a processing block diagram illustrating an exemplary processing block of the vehicle ECU60 related to the control of the three-phase step-up converter 21 during the external charging in the second charging mode. As shown in the figure, the vehicle ECU60 includes a feedforward unit 110, a feedback unit 120, a multiplying unit 122, feedback units 130, 132, 134, adding units 140, 142, 144, and gain setting units 150, 152, 154.

The feedforward unit 110 sets the voltage command VL* of the power line 32 divided by the voltage VH of the power line 28 to the U-phase, V-phase, and W-phase feedforward terms Dffu, Dffv, Dffw. The feedforward terms Dffu, Dffv, Dffw are used for setting the duty commands Du*, Dv*, Dw*, together with the feedback terms Dfbu, Dfbv, Dfbw described later.

The feedback unit 120 calculates the current command In* of the neutral point 22n of the motor 22 using the voltage VL and the voltage command VL* of the power line 32 according to Equation (1). Here, as the voltage command VL*, for example, the output voltage Vs of the power supply device 82 of the charging station 80 is used. Equation (1) is a relational expression in the feedback control for canceling the difference between the voltage VL and the voltage command VL*. In Equation (1), “kp0” indicates the gain of the proportional term, and “ki0” indicates the gain of the integral term.

$${In}^{*} = kp 0 \cdot ( {VL}^{*} - VL ) + ki 0 \cdot \int ( {VL}^{*} - VL ) dt \qquad ( 1 )$$

Multiplying unit 122 sets the current command In* of the neutral point 22n of the motor 22 from the feedback unit 120 multiplied by ⅓ to the U-phase, V-phase, and W-phase current commands Iu*, Iv*, Iw*.

Feedback units 130, 132, 134 calculates the feedback terms Dfbu, Dfbv, Dfbw of the U-phase, the V-phase, and the W-phase according to equations (2) to (4). In this calculation, the feedback units 130, 132, 134 uses the U-phase, V-phase, and W-phase currents Iu, Iv, Iw and the U-phase, V-phase, and W-phase current commands Iu*, Iv*, Iw* from the multiplying unit 122, respectively. Expressions (2) to (4) are relational expressions in the feedback control for canceling the difference between the U-phase, V-phase, and W-phase currents Iu, Iv, Iw and the phase current commands Iu*, Iv*, Iw*. In Expressions (2) to (4), “kpu”, “kpv”, and “kpw” indicate the gain of the proportional term, and “kiu”, “kiv”, and “kiw” indicate the gain of the integral term, respectively. The gains kpu, kiu, kpv, kiv, kpw, kiw are set by the gain setting unit 150.

$$Dfbu = kpu \cdot ( {Iu}^{*} - Iu ) + kiu \cdot \int ( {Iu}^{*} - Iu ) dt \qquad ( 2 )$$

$$Dfbv = kpv \cdot ( {Iv}^{*} - Iv ) + kiv \cdot \int ( {Iv}^{*} - Iw ) dt \qquad ( 3 )$$

$$Dfbw = kpw \cdot ( {Iw}^{*} - Iw ) + kiw \cdot \int ( {Iw}^{*} - Iw ) dt \qquad ( 4 )$$

The adders 140, 142, 144 set the sum of the U-phase, V-phase, and W-phase feedforward terms Dffu, Dffv, Dffw from the feedforward unit 110 and the U-phase, V-phase, and W-phase feedback terms Dfbu, Dfbv, Dfbw from the feedback unit 130,132,134 to the U-phase, V-phase, and W-phase duty commands Du*, Dv*, Dw*, respectively. When the duty commands Du*, Dv*, Dw* of the U-phase, the V-phase, and the W-phase are obtained in this way, the transistors T11, T14 are switched using the duty command Du* of the U-phase. When the duty commands Du*, Dv*, Dw* of the U-phase, the V-phase, and the W-phase are obtained, the transistors T12, T15 are switched using the duty command Dv* of the V-phase. When the duty commands Du*, Dv*, Dw* of the U-phase, the V-phase, and the W-phase are obtained, the transistors T13, T16 are switched using the duty command Dw* of the W-phase. As a result, the power of the power line 32 (the positive electrode side lines 32a1, 32a3 and the negative electrode side line 32b) is boosted in three phases and supplied to the power line 28 (the positive electrode side line 28a and the negative electrode side line 28b).

The gain setting units 150, 152, 154 set the gains kpu, kiu, kpv, kiv, kpw, kiw based on the current command In* of the neutral point 22n of the motor 22 from the feedback unit 120, the U-phase, the V-phase, and the W-phase currents Iu, Iv, Iw, and the abnormal flag Fab. Here, a value 0 is set as an initial value of the abnormal flag Fab, and a value 1 is set when a predetermined abnormality to terminate the external charge occurs. Examples of the predetermined abnormality include an abnormality of the motor 22, an abnormality of the inverter 24, an abnormality of the battery 26, an abnormality of the vehicle ECU60, and an abnormality of the power supply device 82. The predetermined abnormality may further include an abnormality in the stand ECU88, a communication abnormality between ECU60 of vehicles and the stand ECU88, and the like. In the embodiment, when a predetermined anomaly occurs, instead of calculating the current command In* of the neutral point 22n of the motor 22 by the feedback unit 120, the current command In* is changed at a relatively large rate toward 0. Thus, the phase currents Iu, Iv, Iw is changed at a relatively large rate toward the value 0, and the three-phase step-up converter 21 is stopped after the phase currents Iu, Iv, Iw reaches the value 0.

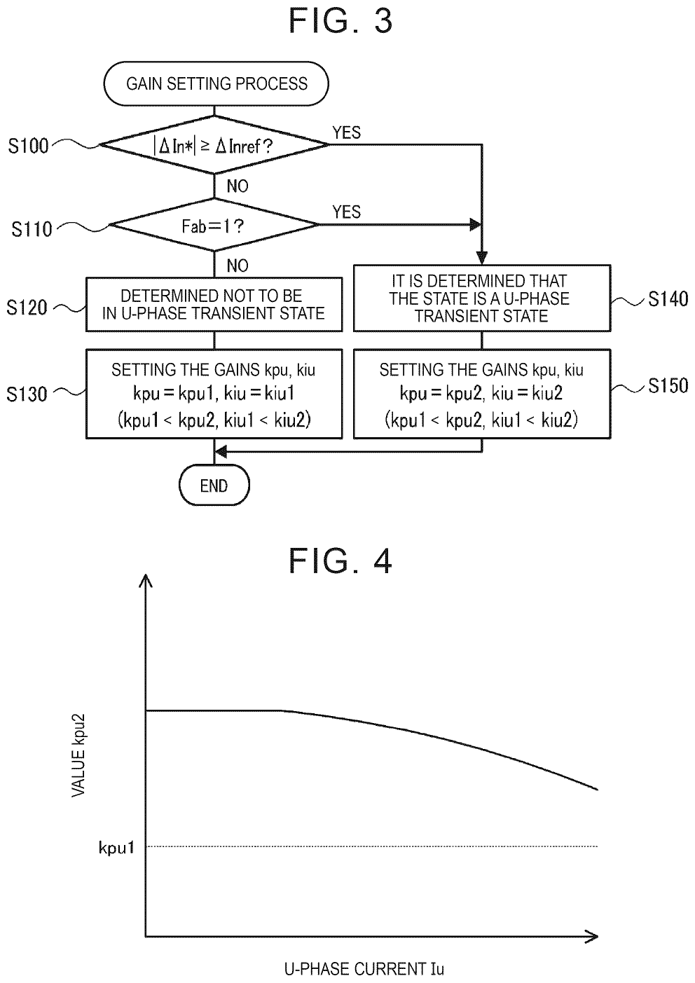

FIG. 3 is a flow chart illustrating an exemplary gain setting process as a process of the gain setting unit 150 executed by the vehicle ECU60. This routine is repeatedly executed during external charging in the second charging mode.

In the gain setting process of FIG. 3, the vehicle ECU60 first determines whether or not the absolute value of the current command change rate ΔIn*, which is the amount of change of the current command In* of the neutral point 22n of the motor 22 per unit time, is equal to or greater than the threshold ΔInref (S100). Further, in the gain setting process of FIG. 3, the vehicle ECU60 determines whether or not the abnormal flag Fab is equal to 1 (S110). Here, the thresholds ΔInref are used to determine whether or not the current command In* of the neutral point 22n of the motor 22 has abruptly changed. When the abnormal flag Fab is switched from the value 0 to the value 1, as described above, the current command In* is changed at a relatively large rate toward the value 0. S100, S110 process is a process of determining whether or not a U-phase transient is present. A U-phase transient state refers to a state in which a transient change (change at a relatively large rate of change) of a U-phase current Iu is assumed and/or is undergoing a transient change. In the U-phase transient state, there can be mentioned a case where the external charging is started, a case where some abnormality occurs during the external charging and the external charging is stopped urgently, and the like.

In some cases, S100 determines that the absolute value of the current command change rate ΔIn* is less than the threshold ΔInref, and S110 determines that the abnormal flag Fab is the value 0. In this case, it is determined that the state is not a U-phase transient (S120), and the normal values kpu1, kiu1 are set to the gains kpu, kiu of the proportional term and the integral term of the U-phase used in the above equation (2) (S130), and the routine is ended.

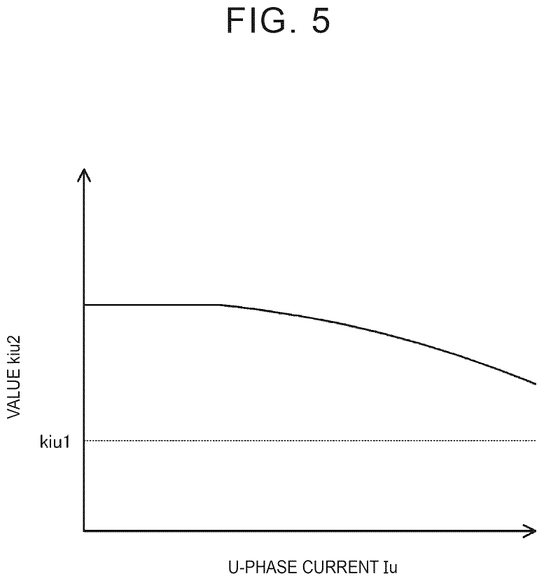

In some cases, the absolute value of the current command change rate ΔIn* is determined to be equal to or greater than the threshold ΔInref in S100, or the abnormal flag Fab is determined to be the value 1 in S110. In this instance, it is determined that the state is a U-phase transient state (S140), and values kpu2, kiu2 larger than the values kpu1, kiu1 are set in the proportional term of the U-phase and the gains kpu, kiu of the integral term (S150), and the routine is ended. Here, the value kpu2 can be set, for example, by deriving a corresponding value kpu2 from the map by applying a U-phase current Iu to a U-phase proportional term gain map that is predetermined by experimentation, analysis, or the like as a relation between the U-phase current Iu and the value kpu2. The value kiu2 can be set, for example, by deriving a corresponding value kiu2 from the map by applying a U-phase current Iu to a U-phase integral term gain map predetermined by experimentation, analysis, or the like as a relation between the U-phase current Iu and the value kiu2. FIG. 4 is an explanatory diagram illustrating an example of a U-phase proportional term gain map, and FIG. 5 is an explanatory diagram illustrating an example of a U-phase integral term gain map. As illustrated in FIGS. 4 and 5, the values kpu2, kiu2 are determined to be smaller (in a linear or curved shape) with continuity as the phase current Iu of the U-phase increases within a range larger than the values kpu1, kiu1, respectively. This is for achieving both the stability of the control of the U-phase and the responsiveness of the phase current Iu to the phase current command Iu*, based on the fact that the inductance Lu of the U-phase decreases due to magnetic saturation when the phase current Iu of the U-phase is relatively large. When the U-phase transient condition is not established, the normal kpu1, kiu1 are set to the gains kpu, kiu of the proportional term and the integral term of the U-phase, respectively. In the U-phase transient condition, values kpu2, kiu2 larger than the values kpu1, kiu1 are set to the gains kpu, kiu of the proportional term and the integral term of the U-phase, respectively. This makes it possible to increase the responsiveness of the U-phase current Iu to the phase current command Iu* in the U-phase transient condition. Moreover, by determining the values kpu2, kiu2 so as to be smaller as the phase current Iu of the U-phase is larger, when the phase current Iu of the U-phase is relatively large, it is possible to achieve both the stability of the control and the responsiveness to the phase current command Iu* of the phase current Iu. Heretofore, the processing of the gain setting unit 150 has been described using the gain setting processing of FIG. 3. Since the processing of the gain setting units 152, 154 is the same as the processing of the gain setting unit 150, detailed description thereof will be omitted.

In battery electric vehicle 20 of the present embodiment described above, during the external charging in the second charging mode, for each phase of the three-phase step-up converter 21 (motor 22 and inverter 24), the difference between the phase current commands Iu*, Iv*, Iw* and the phase currents Iu, Iv, Iw based on the current command In* of the neutral point 22n of the motor 22 is canceled by using the feedback control to set the duty commands Du*, Dv*, Dw* to control the inverter 24. In this case, when the U-phase transient state is not, normal values kpu1, kiu1 are set to the proportional term of the U-phase, the gains kpu, kiu of the integration term, respectively, and when the U-phase transient state, a values kpu2, kiu2 larger than the values kpu1, kiu1 are set to the proportional term of the U-phase, the gains kpu, kiu of the integration term, respectively. This makes it possible to increase the responsiveness of the U-phase current Iu to the phase current command Iu* in the U-phase transient condition. Moreover, the values kpu2, kiu2 are determined so as to decrease as the phase current Iu of the U-phase increases. Thus, when the phase current Iu of the U-phase is relatively large, it is possible to achieve both the stability of the control and the responsiveness to the phase current command Iu* of the phase current Iu. The processing of the V-phase and the W-phase is the same as the processing of the U-phase.

In the above-described embodiment, in the case of external charging in the second charging mode, in the determination of whether or not the U-phase transient state is present, it is determined whether or not the absolute value of the current command change rate ΔIn* which is the change amount per unit time of the current command In* of the neutral point 22n of the motor 22 is equal to or greater than the threshold ΔInref, and it is determined whether or not the abnormal flag Fab is the value 1, but the present disclosure is not limited thereto. For example, instead of determining whether or not the absolute value of the current command change rate ΔIn* is equal to or greater than the threshold value ΔInref, it may be determined whether or not the absolute value of the current command change rate ΔIu* which is the change amount per unit time of the phase current command Iu* of the U-phase is equal to or greater than the threshold value ΔIuref. In addition, only one of the processing using the absolute value of the current command change rate ΔIn* or the absolute value of the current command change rate ΔIu* and the processing using the abnormal flag Fab may be performed. The V-phase and the W-phase can be considered in the same manner as the U-phase.

In the above-described embodiment, the values kpu2, kiu2, as shown in FIG. 4 and FIG. 5, respectively, within a range larger than the values kpu1, kiu1, with continuity as the phase current Iu of the U-phase is large (linear or curved), it is determined to be small, but not limited to this. For example, the values kpu2, kiu2 may be determined so as to decrease stepwise as the phase current Iu of the U-phase increases within a range larger than the values kpu1, kiu1, respectively. In addition, the values kpu2, kiu2 may be determined so as to decrease continuously or stepwise as the phase current command Iu* of the U-phase increases within a range larger than the values kpu1, kiu1, respectively. Further, the values kpu2, kiu2 may each be a constant value within a range larger than the values kpu1, kiu1. The V-phase and the W-phase can be considered in the same manner as the U-phase.

In the above-described embodiment, in the external charging in the second charging mode, the current command In* of the neutral point 22n of the motor 22 is set based on the voltage VL and the voltage command VL* of the power line 32. The required current Intag required for the neutral point 22n of the motor 22 may be set to the current command In*. The required current Intag can then be set, for example, based on the input limit Win of the battery 26, the voltage VL of the power line 32, the allowable output current of the power supply device 82 of the charging station 80, etc.

In the above-described embodiment, the sum of the U-phase, the V-phase, and the W-phase feed-forward terms Dffu, Dffv, Dffw and the U-phase, the V-phase, and the W-phase feed-back terms Dfbu, Dfbv, Dfbw is set to the U-phase, the V-phase, and the W-phase duty commands Du*, Dv*, Dw* during the external charge in the second charge mode. For example, the duty commands Du*, Dv*, Dw* of the U phase, the V phase, and the W phase may be set without using the feed-forward terms Dffu, Dffv, Dffw of the U phase, the V phase, and the W phase.

In the above-described embodiment, battery electric vehicle 20 includes the power line 32 having the positive electrode side lines 32a1, 32a2, 32a3 and the negative electrode side line 32b, and the relays DCRG, DCRB1, DCRB2, DCRN, but is not limited thereto. For example, it is not necessary to include the positive electrode side line 32a2 and the relay DCRB2.

In the above-described embodiment, battery electric vehicle 20 includes the battery 26 as the power storage device, but is not limited thereto. For example, a capacitor or the like may be provided as the power storage device.

In the above-described embodiment, battery electric vehicle 20 including the motor 22, the inverter 24, and the battery 26 has been described, but the present disclosure is not limited thereto. For example, a hybrid electric vehicle configuration that further includes an engine in addition to a hardware configuration similar to that of battery electric vehicle 20 may be employed. In addition, fuel cell electric vehicle configuration may further include a fuel-cell in addition to the hardware configuration similar to that of battery electric vehicle 20.

The correspondence between the main elements of the embodiments and the main elements of the disclosure described in the column of the means for solving the problem will be described. In the embodiment, the motor 22 corresponds to the “motor”, the battery 26 corresponds to the “power storage device”, the inverter 24 corresponds to the “inverter”, and the vehicle ECU60 corresponds to the “control device”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described using the embodiments, it is needless to say that the present disclosure is not limited to such embodiments, and can be implemented in various forms without departing from the gist of the present disclosure.

The present disclosure is applicable to a manufacturing industry of an electrified vehicle and the like.

What is claimed is:

1. An electrified vehicle comprising:
a motor including three-phase coils connected to each other at a neutral point;
a power storage device;
an inverter connected to the power storage device via a power line and configured to drive the motor; and
a control device configured to, during external charging in which electric power supplied from an external power supply to the neutral point is supplied to the power storage device along with voltage conversion by the motor and the inverter, control each phase of the motor and the inverter by setting a duty command using feedback control to cancel out a difference between a phase current and a phase current command based on a current command at the neutral point, wherein
the control device is configured to, when the phase current is in a transient state during the external charging, use a larger value for a gain in the feedback control than when the phase current is not in the transient state.

2. The electrified vehicle according to claim 1, wherein the control device is configured to, when the phase current is in the transient state during the external charging, use, for the gain, a value that is larger than when the phase current is not in the transient state and that decreases as the phase current command or the phase current increases.

3. The electrified vehicle according to claim 1, wherein the control device is configured to use, as the feedback control, a feedforward term based on a voltage command at the neutral point and a voltage on the power line, and a feedback term based on the phase current command, the phase current, and the gain.

4. The electrified vehicle according to claim 1, wherein the control device is configured to determine that the phase current is in the transient state in response to satisfaction of at least one of a condition that a change amount of the current command or the phase current command at the neutral point per unit time is equal to or larger than a predetermined change amount and a condition that an abnormality that leads to termination of the external charging has occurred.
